(19) United States
(12) Patent Application Publication
(10) Pub. No.: US 2018/0293565 A1
(43) Pub. Date: Oct. 11, 2018

(54) TRANSFERRING A TRANSFER CREDIT AMOUNT FROM A FIRST CREDIT MEMORY, ASSIGNED TO A FIRST TELECOMMUNICATIONS TERMINAL, TO A SECOND CREDIT MEMORY, ASSIGNED A SECOND TELECOMMUNICATIONS TERMINAL

(71) Applicant: DEUTSCHE TELEKOM AG, Bonn (DE)

(72) Inventor: Thorsten Sinning, Aachen (DE)

(21) Appl. No.: 15/569,393

(22) PCT Filed: Apr. 26, 2016
(86) PCT No.: PCT/EP2016/059216

§ 371 Date: Oct. 26, 2017

(30) Foreign Application Priority Data
Apr. 28, 2015 (DE) 102015207826.4

(51) Int. Cl. G06Q 20/16; G06Q 20/24

(52) U.S. Cl. CPC G06Q 20/16; G06Q 20/24

(57) ABSTRACT

A method for transferring a transfer credit amount from a first credit memory assigned to a first telecommunications terminal to a second credit memory assigned to a second telecommunications terminal, the first telecommunications terminal having at least one first sensor, and the second telecommunications terminal having at least one second sensor, includes adding a credit amount to the first credit inventory. Events are generated based on sensor signals of the sensors.

### CROSS-REFERENCE TO RELATED APPLICATIONS

This application is a U.S. National Phase application under 35 U.S.C. § 371 of International Application No. PCT/EP2016/059216, filed on Apr. 26, 2016, and claims benefit to German Patent Application No. DE 102015207826.4, filed on Apr. 28, 2015. The International Application was published in German on Nov. 3, 2016 as WO 2016/173999 A1 under PCT Article 21(2).

### FIELD

The invention relates to a method for transferring a transfer credit amount from a first credit memory, assigned to a first telecommunications terminal, to a second credit memory, the second credit memory being assigned to a second telecommunications terminal.

The invention further relates to a system for transferring a transfer credit amount from a first credit memory, assigned to a first telecommunications terminal, to a second credit memory, the second credit memory being assigned to a second telecommunications terminal.

The invention further relates to a telecommunications terminal suitable for use in a system according to the invention and in a method according to the invention.

The present invention further relates to the field of payment methods, in particular to transferring credit via a telecommunications terminal, in particular a smartphone or another portable communications device.

### BACKGROUND

A number of cash-free payment methods are known, most of these methods being based on the existing system of credit cards. In this context, the data of the credit card holder, in particular the card number and name and optionally further security features, are used to establish the identity of the card holder. The payment recipient thus only obtains an assurance of payment; the amount from the credit of the card holder is generally credited to the payment recipient retrospectively.

US 2014/0258110 A1 discloses a smartphone-based virtual wallet that manages the available payment options for an end user. This document basically discloses a method in which a portable smartphone (or an intelligent cellular telephone device) of an end user is provided and in which the smartphone (or the intelligent cellular telephone device) has a display and a sensor. When the payment process is carried out, it is provided that further data from the context of the end user are received via a sensor of the smartphone (or of the intelligent cellular telephone device) or via the microphone thereof so as to safeguard the transaction.

DE 10 2008 035 391 A1 further discloses a method for authenticating an end user to a vendor, the authentication taking place in that a transaction number (Trxld) is compared with a determined or stored transaction number (Trxld), the vendor and/or an end user terminal transmitting a request communication to a central office and the central office providing and communicating a temporarily valid transaction number (Trxld) by means of which the end user can be authenticated to the vendor, or in that the vendor provides a temporarily valid transaction number (Trxld) by means of which the end user can be authenticated to a central office, approval being given after successful authentication to the central office in that an approval message is generated and transmitted to the vendor by the central office.

### SUMMARY

In an exemplary embodiment, the present invention provides a method for transferring a transfer credit amount from a first credit memory assigned to a first telecommunications terminal to a second credit memory assigned to a second telecommunications terminal. The first telecommunications terminal comprises at least one first sensor and wherein the second telecommunications terminal comprises at least one second sensor. The method includes the following steps: in a first step a credit amount is added to the first credit memory; in a second step, subsequent to the first step, the transfer credit amount, as part of the first credit memory, is selected for transfer; in a third step, subsequent to the second step, the first and second telecommunications terminals are brought spatially close to one another and first event information is generated by the first telecommunications terminal on the basis of a first sensor signal from the at least one first sensor of the first telecommunications terminal, and second event information is generated by the second telecommunications terminal on the basis of a second sensor signal from the at least one second sensor of the second telecommunications terminal; in a fourth step, subsequent to the third step, first transfer information is transferred by the first telecommunications terminal to a third-party entity, wherein the first transfer information is the first event information or encrypted and/or anonymized event information generated in accordance with the first event information; in a fifth step, subsequent to the third step, second transfer information is transferred by the second telecommunications terminal to the third-party entity, wherein the second transfer information is the second event information or encrypted and/or anonymized event information generated in accordance with the second event information; and in a sixth step, subsequent to the fourth and fifth steps, the transfer of the transfer credit amount from the first credit memory of the first telecommunications terminal to the second credit memory assigned to the second telecommunications terminal is authorized by the third-party entity depending on a comparison between the first and second transfer information or depending on a comparison between two items of information derived from the first and second transfer information.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic drawing of a method according to the invention for transferring a transfer credit amount from a first credit memory, assigned to a first telecommunications terminal, to a second credit memory, assigned to a second telecommunications terminal.

FIG. 2 is a schematic drawing of first and second telecommunications terminals and the transfer of various items of information in accordance with the method according to the invention.

FIG. 3 is a schematic drawing of a token and a numerical code according to the present invention.

### DETAILED DESCRIPTION

Exemplary embodiments of the invention provide a method and a corresponding system by which credit can be transferred between two users in a technically simple, secure and transparent manner.

In an exemplary embodiment, the invention provides a method for transferring a transfer credit amount from a first credit memory, assigned to a first telecommunications terminal, to a second credit memory, the second credit memory being assigned to a second telecommunications terminal, the first telecommunications terminal comprising at least one first sensor and the second telecommunications terminal comprising at least one second sensor, the method comprising the following method steps:
in a first method step a credit amount is added to the first credit memory,
in a second method step, subsequent to the first method step, the transfer credit amount, as part of the first credit memory, is selected for transfer,
in a third method step, subsequent to the second method step, the first and second telecommunications terminals are brought spatially close to one another and first event information is generated by the first telecommunications terminal on the basis of a first sensor signal from the at least one first sensor of the first telecommunications terminal, and second event information is generated by the second telecommunications terminal on the basis of a second sensor signal from the at least one second sensor of the second telecommunications terminal,
in a fourth method step, subsequent to the third method step, first transfer information is transferred by the first telecommunications terminal to a third-party entity, the first transfer information being the first event information or encrypted and/or anonymized event information generated in accordance with the first event information,
in a fifth method step, subsequent to the third method step, second transfer information is transferred by the second telecommunications terminal to the third-party entity, the second transfer information being the second event information or encrypted and/or anonymized event information generated in accordance with the second event information,
in a sixth method step, subsequent to the fourth and fifth method steps, the transfer of the transfer credit amount from the first credit memory of the first telecommunications terminal to the second credit memory assigned to the second telecommunications terminal is authorized by the third-party entity depending on a comparison between the first and second transfer information or depending on a comparison between two items of information derived from the first and second transfer information.

In an exemplary embodiment, the invention provides a method that makes it possible for two end users of cellular telephones (or other portable telecommunications terminals, such as portable computers and/or portable tablets) to safeguard the transfer of a credit amount from the sending end user (sending the credit amount) to the receiving end user (receiving the credit amount) with as high a level of data protection as possible and in as simple a manner as possible.

It is thus advantageously possible according to the present invention to carry out a credit transfer to the receiving end user with a maximum level of data protection (in particular by way of as high a level of anonymity of the cash transfer as possible).

According to the present invention, a first credit memory is assigned to the first telecommunications terminal, the first credit memory in particular being provided such that it is integrated in the first telecommunications terminal, in particular in a form that is secured in such a way that it is not possible, or is only possible with unreasonably great difficulty, for the end user of the first telecommunications terminal to access and in particular to change the credit stored in the first credit memory. Further, a second credit memory is assigned to the second telecommunications terminal, the second credit memory in particular being provided such that it is integrated in the second telecommunications terminal, in particular in a form that is secured in such a way that it is not possible, or is only possible with unreasonably great difficulty, for the end user of the second telecommunications terminal to access and in particular to change the credit stored in the second credit memory. According to the invention, it is provided that a transfer credit amount is transferred from the first credit memory to or into the second credit memory. In this context, it may be provided that the total credit of the credit stored in the first credit memory in each case corresponds to the transfer credit amount, in other words that after the transfer credit amount has been transferred the first credit memory is “empty” or the credit corresponds to a value of zero (zero balance). Alternatively, according to the invention, it is likewise provided and advantageously possible that the total credit of the credit stored in the first credit memory does not correspond to the transfer credit amount, and thus that the first credit memory is not completely emptied after the transfer credit amount has been transferred. According to the invention, it may in principle likewise be provided that the first credit memory and/or the second credit memory can also have negative credit balances, as well as positive credit balances or as well as the zero balance (which corresponds to an “empty” credit memory). Negative credit balances of this type in the first or second credit memory correspond to a type of credit of the corresponding user, limits preferably existing or being applied for these credits in such a way that a credit amount (in other words a credit balance corresponding to a negative amount) of up to but not beyond a particular value limit is allowed (approximately analogously to the option typically provided by an account-providing credit institute for a current account to be overdrawn (generally by the account user and at least by intention merely in the relatively short term).

According to the invention, the credit stored in the first and second credit memory is in particular cash credit, in other words data stored in the first and second credit memory represent cash amounts in at least one common currency such as U.S. dollars ($), British pounds (£), European euros (€), Swiss francs (CHF), Japanese yen (¥) or Chinese renminbi (RMB). Alternatively, it is also possible for the credit stored in the first credit memory to be credit in a first currency and for the credit stored in the second credit memory to be credit in a different, second currency, for example U.S. dollars ($) in the first credit memory and euros (€) in the second credit memory. As an alternative to the credit stored in the first and second credit memory being cash credit, according to the invention it may likewise be provided that these credits are credit in alternative (to cash credit) credit units (which may not have a cash value), for example bonus points, loyalty points, travel tickets for transportation, entry tickets for a particular event, authorization (also potentially time-limited) to use an item, for example a motor vehicle or another vehicle, for example a bicycle, or the like.

According to the invention, the first telecommunications terminal comprises at least one first sensor and the second telecommunications terminal comprises at least one second sensor. Conventionally, telecommunications terminals comprise a plurality of different sensors, for example one or more inertial sensors (for example for measuring the linear acceleration and/or for measuring the rate of rotation or the angular acceleration), one or more acoustic sensors (in particular microphones), one or more optical sensors (in particular a camera) and/or one or more antennae that receive electromagnetic signals. According to the invention, it is provided that the following method steps are carried out:
in a first method step a credit amount is added to the first credit memory,
in a second method step, subsequent to the first method step, the transfer credit amount, as part of the first credit memory, is selected for transfer,
in a third method step, subsequent to the second method step, the first and second telecommunications terminals are brought spatially close to one another and first event information is generated by the first telecommunications terminal on the basis of a first sensor signal from the at least one first sensor of the first telecommunications terminal, and second event information is generated by the second telecommunications terminal on the basis of a second sensor signal from the at least one second sensor of the second telecommunications terminal,
in a fourth method step, subsequent to the third method step, first transfer information is transferred by the first telecommunications terminal to a third-party entity, the first transfer information being the first event information or encrypted and/or anonymized event information generated in accordance with the first event information,
in a fifth method step, subsequent to the third method step, second transfer information is transferred by the second telecommunications terminal to the third-party entity, the second transfer information being the second event information or encrypted and/or anonymized event information generated in accordance with the second event information,

In this situation, because both the first transfer information (received either directly or indirectly from the first telecommunications terminal) and the second transfer information (received either directly or indirectly from the second telecommunications terminal) are in principle present at or with the third-party entity, it is possible for the third-party entity to check or compare the first and the second transfer information. If the comparison result of this comparison is either that the first and second transfer information are identical to one another or else that the first and second transfer information are not identical to one another but have only negligible differences, in other words in particular are within a predetermined tolerance threshold or have a difference exceeding a predetermined measure, the transfer, desired by the user of the first telecommunications terminal, of the transfer credit amount from the first credit memory of the first telecommunications terminal to the second credit memory assigned to the second telecommunications terminal is authorized or approved. As an alternative to the first and the second transfer information being used in this comparison, according to the present invention, it is alternatively likewise possible and preferred for two items of information to be compared that are in turn derived from the first and second transfer information (for example by a decryption operation), in other words for a first item of information to be obtained, for example by a decryption operation, from the first transfer information, and for a second item of information to be obtained, for example also by a decryption operation, from the second transfer information, and for the two items of information to be compared with one another. In the same way as when the first and second transfer information are themselves compared, it also holds when the first and second items of information are compared that if the comparison result of this comparison is either that the first and second items of information are identical to one another or else that the first and second items of information are not identical to one another but have only negligible differences, the transfer, desired by the user of the first telecommunications terminal, of the transfer credit amount from the first credit memory of the first telecommunications terminal to the second credit memory assigned to the second telecommunications terminal is authorized or approved. If this comparison (in other words the comparison of the first and second transfer information or alternatively the comparison of the items of information derived from this transfer information) turns out in such a way that the differences are non-negligible, in other words in particular being above the predetermined tolerance threshold or having a difference exceeding a predetermined measure, the transfer, desired by the user of the first telecommunications terminal, of the transfer credit amount from the first credit memory of the first telecommunications terminal to the second credit memory assigned to the second telecommunications terminal is not authorized or approved.

According to the invention, it is preferably provided that the transfer of the transfer credit amount from the first credit memory of the first telecommunications terminal to the second credit memory assigned to the second telecommunications terminal is declined by the third-party entity, depending on the comparison between the first and second transfer information or depending on the comparison between two items of information derived from the first and second transfer information, if the first and second transfer information or the two items of information derived from the first and second transfer information have a difference from one another that exceeds a predetermined measure.

As a result, according to the invention, it is advantageously possible for the security of the method according to the invention against attempts at fraud to be comparatively high.

According to the invention, it is further preferred that in the third method step the first and second telecommunications terminals are brought spatially close to one another and/or subjected to an external effect in such a way that the first sensor signal and the second sensor signal are highly correlated with one another, in particular the at least one first sensor and the at least one second sensor each being formed as
an inertial sensor, and the first and second telecommunications terminals being subjected to a shared movement or a relative movement of the first telecommunications terminal relative to the second telecommunications terminal as an external effect, and/or
an acoustic sensor, and the first and second telecommunications terminals being subjected to an acoustic event or an acoustic signal as an external effect, in particular generated by the first and/or second telecommunications terminal and/or generated by a further electrical device located spatially close to the first and second telecommunications terminals, and/or
an optical sensor, in particular a camera, and the first and second telecommunications terminals interpreting an optical signal, in particular an image or a visual representation, as an external effect, in particular generated by the first and/or second telecommunications terminal and/or generated by a further electrical device located spatially close to the first and second telecommunications terminals, and/or
an antenna that receives electromagnetic signals, and the first and second telecommunications terminals being subjected to an electromagnetic signal, in particular a beacon signal, as an external effect, in particular generated by the first and/or second telecommunications terminal and/or generated by a further electrical device located spatially close to the first and second telecommunications terminals.

It is thus advantageously possible according to the invention for the transfer credit amount to be transferred in a simple and intuitive manner. For example, the two telecommunications terminals can be held in one hand and subjected to a shaking movement that is detected by the sensor or plurality of sensors of each of the first telecommunications terminal and the second telecommunications terminal. As a result of the shaking movement or else as a result of the external (to the telecommunications terminals) event or the external effect, the sensor signal is produced or generated by the sensor or plurality of sensors in each of the telecommunications terminals (in other words the first sensor signal by the sensor or plurality of sensors of the first telecommunications terminal and the second sensor signal by the sensor or plurality of sensors of the second telecommunications terminal), these sensor signals being highly correlated with one another as a result of the external effect on the two telecommunications terminals, in particular having a correlation coefficient of greater than or equal to 0.8, preferably of greater than or equal to 0.95, preferably of greater than or equal to 0.99.

According to the invention, it is further preferred for sensor-related information, in particular sensor calibration information, to be exchanged between the first telecommunications terminal and the second telecommunications terminal temporally before, during or after the third method step.

As a result, it is advantageously possible according to the invention for the sensors, in each case used to generate the sensor signals, of the first and second telecommunications terminals to be calibrated. As a result of this sensor calibration, it is advantageously possible according to the invention for the sensors used in each case to be adapted in such a way that the sensor signals generated thereby already have comparatively low scattering when generated, such that it is accordingly subsequently possible to keep the predetermined tolerance threshold (or the predetermined measure of the difference in the information to be compared) before the credit transfer is approved as low as possible, and thus to ensure a high level of security in the method according to the invention.

According to the invention, it is preferably provided that the first credit memory is permanently assigned to the first telecommunications terminal, in particular is rigidly connected to the first telecommunications terminal, or the first credit memory is part of the first telecommunications terminal, the second credit memory in particular also being permanently assigned to the second telecommunications terminal, in particular rigidly connected to the second telecommunications terminal, or the second credit memory being part of the second telecommunications terminal.

Advantageously, according to the invention this has the result that, because of the fixed connection between the telecommunications terminal in question and the associated credit memory, unauthorized access to the (first or second) credit memory can be prevented, and the level of security of the method according to the invention can thus be increased.

According to the invention, it is further preferably provided that the first event information when generated by the first telecommunications terminal and the second event information when generated by the second telecommunications terminal are in the form of a secret that is provided or transferred to unauthorized third parties merely in encrypted form during the third method step to the sixth method step to authenticate the transfer of the transfer credit amount.

As a result, it is advantageously possible according to the invention for the level of security of the method according to the invention to be improved.

According to the invention, it is further preferred for the first credit memory to comprise a credit contained in the first credit memory in a secured form.

The present invention also relates to a system for transferring a transfer credit amount from a first credit memory, assigned to a first telecommunications terminal, to a second credit memory, the system comprising the first telecommunications terminal, the second telecommunications terminal and a third-party entity, the second credit memory being assigned to a second telecommunications terminal, the first telecommunications terminal comprising at least one first sensor and the second telecommunications terminal comprising at least one second sensor, the system being configured in such a way that:
a credit amount is added to the first credit memory,
the transfer credit amount, as part of the first credit memory, is selected for transfer,
the first and second telecommunications terminals are brought spatially close to one another and first event information is generated by the first telecommunications terminal on the basis of a first sensor signal from the at least one first sensor of the first telecommunications terminal, and second event information is generated by the second telecommunications terminal on the basis of a second sensor signal from the at least one second sensor of the second telecommunications terminal,
first transfer information is transferred by the first telecommunications terminal to the third-party entity, the first transfer information being the first event information or encrypted and/or anonymized event information generated in accordance with the first event information,
second transfer information is transferred by the second telecommunications terminal to the third-party entity, the second transfer information being the second event information or encrypted and/or anonymized event information generated in accordance with the second event information,
the transfer of the transfer credit amount from the first credit memory of the first telecommunications terminal to the second credit memory assigned to the second telecommunications terminal is authorized by the third-party entity depending on a comparison between the first and second transfer information or depending on a comparison between two items of information derived from the first and second transfer information, or else declined if the first and second transfer information or the two items of information derived from the first and second transfer information have a difference from one another that exceeds a predetermined measure.

As a result, according to the present invention, in particular with regard to the system according to the invention, it becomes much simpler and easier for an end user to transfer credit to another telecommunications terminal.

According to the invention, it is further preferably provided that the third-party entity is a clearing house.

This particularly advantageously makes it possible for security to be particularly ensured when the method according to the invention is carried out since only specially authorized clearing houses take on the function of the third-party entity.

The present invention further relates to a telecommunications terminal for transferring a transfer credit amount from a first credit memory, assigned to the telecommunications terminal acting as a first telecommunications terminal, to a second credit memory, the second credit memory being assigned to a second telecommunications terminal, the first telecommunications terminal comprising at least one first sensor and the second telecommunications terminal comprising at least one second sensor, the first telecommunications terminal being configured in such a way that:
a credit amount is added to the first credit memory,
the transfer credit amount, as part of the first credit memory, is selected for transfer,
the first and second telecommunications terminals are brought spatially close to one another and first event information is generated by the first telecommunications terminal on the basis of a first sensor signal from the at least one first sensor of the first telecommunications terminal, and second event information is generated by the second telecommunications terminal on the basis of a second sensor signal from the at least one second sensor of the second telecommunications terminal,
first transfer information is transferred by the first telecommunications terminal to the third-party entity, the first transfer information being the first event information or encrypted and/or anonymized event information generated in accordance with the first event information,
second transfer information is transferred by the second telecommunications terminal to the third-party entity, the second transfer information being the second event information or encrypted and/or anonymized event information generated in accordance with the second event information,
the transfer of the transfer credit amount from the first credit memory of the first telecommunications terminal to the second credit memory assigned to the second telecommunications terminal is authorized by the third-party entity depending on a comparison between the first and second transfer information or depending on a comparison between two items of information derived from the first and second transfer information, or else declined if the first and second transfer information or the two items of information derived from the first and second transfer information have a difference from one another that exceeds a predetermined measure.

As a result, according to the present invention, in particular with regard to the telecommunications terminal according to the invention, it becomes possible to transfer credit from the first telecommunications terminal to the second telecommunications terminal with comparatively low technical complexity and/or financial outlay.

The present invention also relates to a telecommunications terminal for transferring a transfer credit amount from a first credit memory, assigned to a first telecommunications terminal, to a second credit memory, the second credit memory being assigned to the telecommunications terminal acting as a second telecommunications terminal, the first telecommunications terminal comprising at least one first sensor and the second telecommunications terminal comprising at least one second sensor, the second telecommunications terminal being configured in such a way that:
a credit amount is added to the first credit memory,
the transfer credit amount, as part of the first credit memory, is selected for transfer,
the first and second telecommunications terminals are brought spatially close to one another and first event information is generated by the first telecommunications terminal on the basis of a first sensor signal from the at least one first sensor of the first telecommunications terminal, and second event information is generated by the second telecommunications terminal on the basis of a second sensor signal from the at least one second sensor of the second telecommunications terminal,
first transfer information is transferred by the first telecommunications terminal to the third-party entity, the first transfer information being the first event information or encrypted and/or anonymized event information generated in accordance with the first event information,
second transfer information is transferred by the second telecommunications terminal to the third-party entity, the second transfer information being the second event information or encrypted and/or anonymized event information generated in accordance with the second event information,
the transfer of the transfer credit amount from the first credit memory of the first telecommunications terminal to the second credit memory assigned to the second telecommunications terminal is authorized by the third-party entity depending on a comparison between the first and second transfer information or depending on a comparison between two items of information derived from the first and second transfer information, or else declined if the first and second transfer information or the two items of information derived from the first and second transfer information have a difference from one another that exceeds a predetermined measure.

As a result, according to the invention, it is advantageously possible to use a telecommunications terminal of this type within the meaning of the method according to the invention and to thus transfer a transfer credit from the first telecommunications terminal to the second telecommunications terminal in a simple manner.

The present invention further relates to a computer program comprising program code by way of which all steps of the method according to the invention can be carried out when the computer program is run on a programmable device and/or on a programmable first telecommunications terminal and/or on a programmable second telecommunications terminal and/or on a device, in particular a network node, of a system, in particular in part on a programmable device and/or in part on a programmable first telecommunications terminal and/or in part on a programmable second telecommunications terminal and/or on a device, in particular a network node, of a system.

Further, the present invention also relates to a computer program product comprising a computer-readable medium and a computer program stored on the computer-readable medium and comprising program code that is suitable for all steps of the method according to the invention to be able to be carried out when the computer program is run on a programmable device and/or on a programmable first telecommunications terminal and/or on a programmable second telecommunications terminal and/or on a device, in particular a network node, of a system, in particular in part on a programmable device and/or in part on a programmable first telecommunications terminal and/or in part on a programmable second telecommunications terminal and/or on a device, in particular a network node, of a system.

Further details, features and advantages of the invention can be found in the drawings and the following description of preferred embodiments with reference to the drawings. The drawings merely illustrate embodiments of the invention that are given by way of example and do not limit the basic concepts of the invention.

In the various drawings, like parts are always provided with the same reference numerals and are therefore also generally only named and mentioned once.

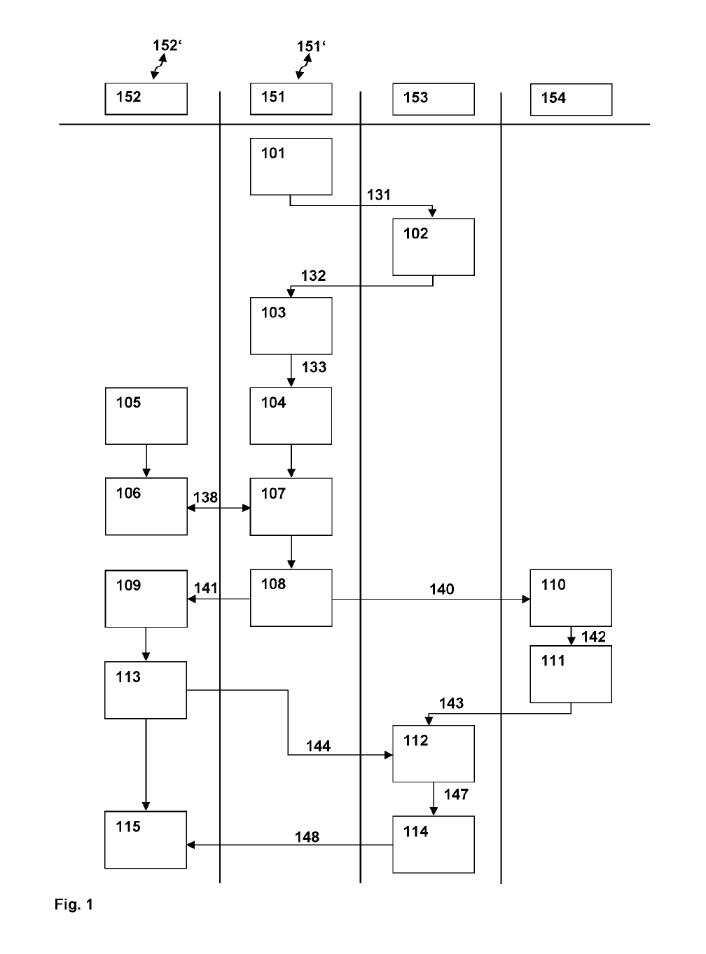

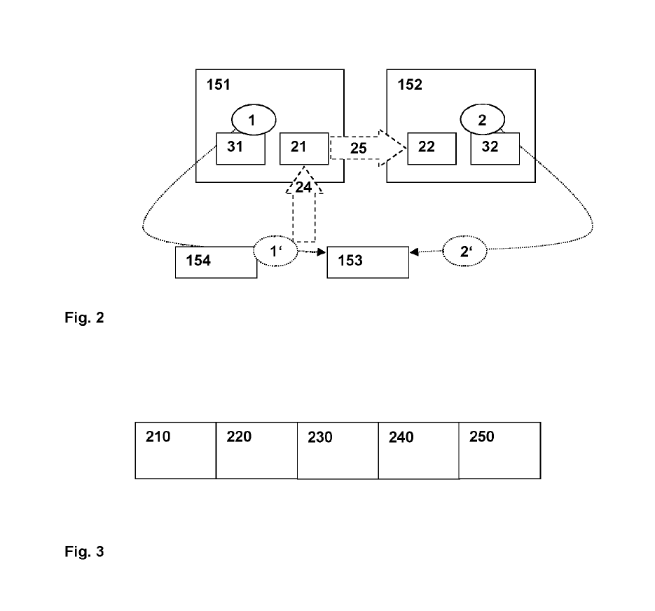

FIG. 1 schematically shows a method sequence of the method according to the invention. Here, it is assumed that a first user 151′ (or a first end user) operates or has available a first telecommunications terminal 151 and a second user 152′ (or a second end user) operates or has available a second telecommunications terminal 152. FIG. 2 schematically shows the first and second telecommunications terminals and the transfer, provided in accordance with the method according to the invention, of various items of information.

According to the present invention, a transfer credit amount 25 is intended to be transferred from a first credit memory 21, assigned to the first telecommunications terminal 151, to a second credit memory 22, the second credit memory 22 being assigned to the second telecommunications terminal 152 (cf. FIG. 2). According to the invention, the first telecommunications terminal 151 comprises at least one first sensor 31. Further, the second telecommunications terminal 152 also comprises at least one second sensor 32. Naturally, it is possible, and is typically usually the case in practice, that either the first telecommunications terminal 151 or the second telecommunications terminal 152 or else both telecommunications terminals 151, 152 comprise a plurality of sensors.

According to the invention, the method comprises the method steps whereby in a first method step a credit amount 24 is added to the first credit memory 21, in a second method step the transfer credit amount 25, as part of the first credit memory 21, is selected for transfer, and in a third method step the first and second telecommunications terminals 151, 152 are brought spatially close to one another and/or subjected to an external effect. In this context, first event information 1 is generated by the first telecommunications terminal 151 on the basis of a first sensor signal from the at least one first sensor 31, and second event information 2 is generated by the second telecommunications terminal 152 on the basis of a second sensor signal from the at least one second sensor 32. In particular, according to the invention, it is provided that the first and second telecommunications terminals 151, 152 are brought spatially close to one another and/or subjected to an external effect in such a way that the first sensor signal and the second sensor signal are highly correlated with one another.

In a fourth and fifth method step, respectively, first transfer information 1′ is transferred by the first telecommunications terminal 151 to a third-party entity 153 and second transfer information 2′ is transferred by the second telecommunications terminal 152 also to the third-party entity 153. In this context, either the first transfer information 1′ corresponds to the first event information 1 (in other words unchanged or largely unchanged or at least substantially unchanged) or else the first transfer information 1′ corresponds to encrypted and/or anonymized event information generated in accordance with the first event information 1. Accordingly, it is provided that either the second transfer information 2′ corresponds to the second event information 2 or else the second transfer information 2′ is encrypted and/or anonymized event information generated in accordance with the second event information 2.

In a subsequent sixth method step, the transfer of the transfer credit amount 25 from the first credit memory 21 of the first telecommunications terminal 151 to the second credit memory 22 assigned to the second telecommunications terminal 152 either is or is not authorized by the third-party entity 153; this is dependent on a comparison (or the result thereof) between the first and second transfer information 1′, 2′ or dependent on a comparison between two items of information derived from the first and second transfer information 1′, 2′.

The authentication is triggered by way of first event information in the first telecommunications terminal and second event information in the second telecommunications terminal, or the first event information and the second event information form the basis for carrying out the authentication. The event information (in each case) is for example a signal from the movement sensor (or acceleration sensor) or the gravitation sensor (or gravity sensor).

According to the invention, the preparation takes place in particular analogously in both devices: the signal from the sensor is prepared as follows in both devices. The signal from the sensor is first sampled and converted into a digital signal. The digital signal is filtered by a low-pass filter or a band-pass filter. Thereupon, a fast Fourier transformation is undertaken in the frequency range. The signal results in a data set of frequencies and the amplitudes thereof that occur in the signal. According to a preferred embodiment of the present invention, this data set forms the associated transfer information for the other or second telecommunications terminal (this data set of the transfer information being received and stored in particular in the second telecommunications terminal and correlating with the event information prepared in the second telecommunications terminal by the above-described method). In a preferred embodiment of the present invention, the two signals are prepared in such a way that they have the same number of sampling values.

The correlation between the transfer information (in other words the first and second transfer information) (or alternatively also (in a further embodiment of the invention) between the transfer information and the event information) is carried out by cross-correlation or by calculating a cross-correlation. The formula for the cross-correlation is as follows:

$${R}_{xy} ( τ ) = {lim}_{{T}_{F} \to ∞} \frac{1}{{T}_{F}} {\int }_{- {T}_{F} / 2}^{{T}_{F} / 2} {x}^{*} ( t ) y ( t + τ ) dt$$

Transfers in the present case of the discrete, sampled signals at the point n:

$$( x * y ) [ n ] = {\sum }_{m = - ∞}^{∞} {x}^{*} [ m ] y [ n + m ]$$

The data sets of the transfer information (in other words the first and second transfer information) (or alternatively also the transfer information and the event information) thus form a correlation signal x*y in accordance with the above formula, which is a measure of the similarity of the items of information being compared with one another. According to the invention, the correlation signal is divided in particular by the absolute value thereof, and thus normalized.

Normalization results in an amplitude of the correlation signal; the maximum value is referred to as a correlation coefficient and may vary within the range between 0 and 1, where 1 denotes the maximum similarity of the two signals (or items of information) x, y being compared with one another (or alternatively of the data sets of the transfer information and the event information).

A match between the signals, in other words the original event information (in other words the first event information and the second event information), can be assumed if these sensor signals are highly correlated with one another as a result of the external effect on both telecommunications terminals, in particular if they have a correlation coefficient of greater than or equal to 0.8, preferably of greater than or equal to 0.95, or preferably of greater than or equal to 0.99.

The data sets of the transfer information (in other words the first transfer information and the second transfer information) (or alternatively the transfer information and/or the event information) may also be encrypted. If both are encrypted in such a way that the information thereof is encrypted similarly and the contained information is still kept transparent, these encrypted data sets can also be correlated.

Other signals for forming data sets that are similar or that are comparable by correlation are also known to a person skilled in the art. Thus, these signals may also be evaluated by recording a sound signal recorded by the two telecommunications terminals or by recording the signals generated by one of the devices and recorded by the other telecommunications terminal. Signals of this type are recorded or generated and recorded for example by the microphone, the speaker, the display, the camera, the fingerprint reader or fingerprint sensor, or else at external sensors such as pulse measurers, movement sensors or acceleration sensors, gravitation sensors (or optionally also gravity sensors), microphones, speakers, displays, cameras, fingerprint readers or biometric sensors. An application (mentioned in the following in conjunction with FIG. 1) may also have or gain access to a close-range radio, in particular NFC, Bluetooth, Bluetooth LE, WLAN, Wi-Fi, ZigBee or LPD (low-power device). Services or services on ISM (industrial scientific medical) frequency ranges are also possible for authentication. For all of these signals, the signal generation is based on a local event or acts uniformly on a limited space, acting as a close range, on the telecommunications terminals, the event being suitable for proving that the telecommunications terminals are close to one another and are brought together simultaneously.

In the following, the method is also described with reference to FIG. 1:

The first user 151′ (of the first telecommunications terminal 151) loads a cash amount onto his cellular telephone from his bank account or credit card account as credit. The credit is subsequently stored in an encrypted memory region (first credit memory 21) of the cellular telephone (first telecommunications terminal 151). The encrypted memory region (first credit memory 21) may also be the SIM card of the cellular telephone (in other words the first telecommunications terminal 151) or an additional memory card of the cellular telephone. FIG. 1 shows the method for transferring anonymous data for paying via an application (app). The user 151′ has installed on his device (first telecommunications terminal 151) an application that has access to an encrypted memory region (first credit memory 21) of the device (first telecommunications terminal 151) or the SIM card of the user 151′. The application also has access to in particular at least one sensor (first sensor 31) of the device, preferably the movement sensor or acceleration sensor, the gravitation sensor (or optionally also the gravity sensor), the microphone, the speaker, the display, the camera, the fingerprint reader or fingerprint sensor, or else to external sensors such as pulse measurers, movement sensors or acceleration sensors, gravitation sensors (or optionally also gravity sensors), microphones, speakers, displays, cameras, fingerprint readers or biometric sensors. The application also has access to a close-range radio, in particular NFC, Bluetooth, Bluetooth LE, WLAN, Wi-Fi, ZigBee or LPD (low-power device) services or services on ISM (industrial scientific medical) frequency ranges.

The second user 152′ also has installed on his device (second telecommunications terminal 152) an application (or app) that has access to an encrypted memory region (second credit memory 22) of the device or the SIM card of the user 152′. The application (of the second telecommunications terminal 152) also has access to in particular at least one sensor (second sensor 32) of the device, preferably the movement sensor or acceleration sensor, the gravitation sensor (or else a gravity sensor), the microphone, the speaker, the display, the camera, the fingerprint reader or fingerprint sensor, or else external sensors such as pulse measurers, movement sensors or acceleration sensors, gravitation sensors (or optionally also gravity sensors), microphones, speakers, displays, cameras, fingerprint readers (or fingerprint sensors) or biometric sensors. The application (of the second telecommunications terminal 152) also has access to a close-range radio, in particular NFC, Bluetooth, Bluetooth LE, WLAN (wireless local area network), Wi-Fi, ZigBee or LPD services or services on ISM frequency ranges.

In step 101, the user 151′ loads credit from his bank account onto his device (first telecommunications terminal 151). The device (first telecommunications terminal 151) stores the credit in an encrypted manner in a preferably secured memory region (first credit memory 21) or on the SIM card of the device (first telecommunications terminal 151) of the user 151′. In step 131, the credit is debited from the bank account of the user 151′ and stored on the device (first telecommunications terminal 151) via an encryption method.

In a preferred embodiment of the present invention, the following holds for the configuration of the credit and of the transfer of the credit amount. The credit is stored in particular in the form of a digital data set that contains data about the amount of the credit, optionally also data about the authenticity, the validity, the currency, the drawer, and additionally an error detecting number. This data set is preferably encrypted by a common encryption method. The data set is brought into a data format for exchanging the credit to the second telecommunications terminal. The data format comprises an item of information about the amount, the preferred clearing house and a check digit.

In particular, the data are preferably stored in the secured memory region so as to prevent copying or loss by theft of the telecommunications terminal or to make manipulation unappealing.

The data set in the prescribed data format is transferred from one telecommunications terminal to the other telecommunications terminal preferably via a close-range radio, or an acoustic or optical signal, and this is how the preceding signal is suitable for proving that the telecommunications terminals are close to one another and are brought together simultaneously.

Alternatively (or in addition), however, it may also be provided for the transfer from one telecommunications terminal to the other telecommunications terminal to take place via the Internet, via WLAN or via the mobile radio; in this case, it is ensured that the telecommunications terminals are spatially and temporally close (merely) by way of the event information/transfer information.

In this context, FIG. 3 shows a preferred data format. The data format comprises an item of information about the amount 220, the preferred clearing house 210 and a check digit 240. A part 230 of the data format is reserved for a numerical code or token that in the method is used for authenticating payments made from the credit of the customer to third parties. The part 250 of the data format 200 contains address information.

In step 102 in FIG. 1, credit is debited, in other words credit is transferred from the bank to the device of the user 151′, the responsible clearing house (or third-party entity 153) optionally being informed that credit has been debited for a particular amount for which it has been named as the clearing house, and also as to the size of the amount, so as to detect an obvious case of misuse during the subsequent confirmation of the authentication by plausible estimation of the expected size of requests for authentication and to limit the harm potentially resulting therefrom.

In step 132, credit is transferred in coded form to the first telecommunications terminal 151 or the first credit memory 21 thereof.

In step 103, it is displayed to the user 151′ that the credit is available. In step 133, the user 151′ indicates on his device (first telecommunications terminal 151) a payment of an amount X (transfer credit amount 25) to the device (second telecommunications terminal 152) of the user 152′. In step 104, thereupon, the credit code of the credit (in the first credit memory 21) provided locally on the device (first telecommunications terminal 151) is reduced by the amount X to be transferred (transfer credit amount 25).

In step 105, the payment of the amount X (transfer credit amount 25) is indicated by way of the device (second telecommunications terminal 152) of the user 152′, but is not credited either to the account of the user 152′ or to his device (second telecommunications terminal 152). In step 106, the close-range radio and the sensors in the device (second telecommunications terminal 152) are switched on by the user 152′. In step 107, the close-range radio and the sensors are switched on in the device (first telecommunications terminal 151) of the user 151′. The credit is only subsequently credited, when the amount X (transfer credit amount 25), by way of the numerical code 1 (first event information) present on a second path of the clearing house (or third-party entity 153), the transfer of the amount X (transfer credit amount 25) (and in particular the fact that it is covered by the credit of the user 151′) has been authenticated. In both devices, the payment of the amount Xis prepared by generating a shared secret, unknown to third parties, in the form of the numerical codes 1 and 2 (first event information 1 and second event information 2).

In step 138, the two telecommunications terminals 151, 152 come into contact with one another or are brought spatially close to one another. The devices calibrate the sensors 31, 32 thereof in such a way that a shared event is recorded in the same way by both devices. In step 108, the two devices record a shared event, which is converted to the associated secret numerical code 1 or token 1 and numerical code 2 or token 2 in the respective devices 151, 152.

This shared event may for example be common shaking of the two devices (or telecommunications terminals 151, 152) in one hand. The shared event may further be transferring a sound, recording ambient noises, recording a beacon signal that is only present locally and location-dependently, for example a Bluetooth close-range radio beacon.

The shared event may further be: taking photographs, exchanging jointly generated random numbers and the like. The shared event may also be a combination of the aforementioned events. Thus, it is also possible for a locally receivable beacon signal and simultaneously a GPS signal to be recorded on the two devices. A locally receivable beacon signal and the field strength of the beacon signal may also be recorded simultaneously on the two devices. A locally receivable beacon signal and a jointly recorded movement pattern may also be recorded on the two devices.

To check the authenticity of the payment, a third-party entity 153, in particular a clearing house, is agreed upon. The identifier of the responsible clearing house is exchanged between the devices during the payment process.

The options for combination may be as desired, the combination of features serving to improve the probability of finding a shared event which forms a numerical code 1 (first event information) and a numerical code 2 (second event information) that can be recognized on both devices.

To prevent measurement and calculation errors, the two numerical codes 1 (first event information) and 2 (second event information) are checked between the devices, optionally after the measurement process, in such a way that a shared event, in other words the numerical codes 1 (first event information) and 2 (second event information) being equal, is ensured.

If deviations occur that are above an expected error tolerance threshold, the payment process is aborted for security reasons by way of an error message.

In step 108, the shared event or the external effect (shaking) is converted to or generates a secret numerical code (first event information 1). In step 109, the shared event or the external effect (shaking) is converted to or generates a secret numerical code (second event information 2). In step 141, the numerical codes (first event information 1 and second event information 2) are checked.

Further, in step 108, the origin data of the numerical code 1 are deleted from the device of the user 151′. The anonymization is additionally secured by the following procedure. In step 140, the numerical code 1 (first event information 1) is transmitted to an anonymization unit 154. This anonymization unit 154 may for example operate according to the store-and-forward method.

In step 110, the message of the numerical code 1 (first event information 1) is recorded. In step 142, the origin data of the numerical code are deleted and passed on with a changed identity. The identifier of the responsible clearing house (or the third-party entity 153) and the indicated cash amount are kept.

In step 111, the numerical code 1 is received in an anonymized form. In step 143, the anonymized numerical code 1′ (or the first transfer information 1′) calculated from the numerical code 1 is passed on to the clearing house.

In step 112, the clearing house stores the anonymized numerical code 1′ (first transfer information) and waits for an authentication request by the device (second telecommunications terminal 152) of the user 152′ from the open Internet.

In step 113, a request to the clearing house is made using the anonymized numerical code. In step 144, the device (second telecommunications terminal 152) of the user 152′ makes the request for authentication of the payment process. The identifier of the responsible clearing house has been exchanged between the devices previously during the payment process. Subsequently, in step 147, the clearing house compares the two provided numerical codes, which can be assigned to the payment process. In this case, these are the anonymized numerical code 1′ (second transfer information 1′) transmitted by the anonymization unit 154 and the numerical code 2 (second event information 2 or the second transfer information 2′) from the requesting device (second telecommunications terminal 152) that is compared therewith.

The two numerical codes 1′, 2 or tokens share the secret that was measured or received from the beacon by both devices and shared between them during the payment process. This secret is only revealed to these two devices, and so if the two numerical codes are identical it is ensured that the two numerical codes are each describing the one identical payment process as the source thereof. If the anonymized numerical code 1′ (or the first transfer information) matches the requesting numerical code 2 or the second transfer information 2′, the clearing house (or the third-party entity 153) announces in step 148 or in step 114 that the amount has been authenticated.

As a result of step 115, the authentication process in the device (second telecommunications terminal 152) of the user 152′ is terminated and the credit of the amount X (transfer credit amount 25) of the user 151′ is credited to the credit of the user 152′.

The crediting may take place directly to the prepaid credit of the user 152′ on the device (second telecommunications terminal 152) or else in the form of crediting to the account of the user 152′ externally to the device (second telecommunications terminal 152).

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for transferring a transfer credit amount from a first credit memory assigned to a first telecommunications terminal to a second credit memory is assigned to a second telecommunications terminal, wherein the first telecommunications terminal comprises at least one first sensor and wherein the second telecommunications terminal comprises at least one second sensor, wherein the method comprises the following steps:
in a first step a credit amount is added to the first credit memory;
in a second step, subsequent to the first step, the transfer credit amount, as part of the first credit memory, is selected for transfer;
in a third step, subsequent to the second step, the first and second telecommunications terminals are brought spatially close to one another and first event information is generated by the first telecommunications terminal on the basis of a first sensor signal from the at least one first sensor of the first telecommunications terminal, and second event information is generated by the second telecommunications terminal on the basis of a second sensor signal from the at least one second sensor of the second telecommunications terminal;
in a fourth step, subsequent to the third step, first transfer information is transferred by the first telecommunications terminal to a third-party entity, wherein the first transfer information is the first event information or encrypted and/or anonymized event information generated in accordance with the first event information;
in a fifth method step, subsequent to the third method step, second transfer information is transferred by the second telecommunications terminal to the third-party entity wherein the second transfer information is the second event information or encrypted and/or anonymized event information generated in accordance with the second event information; and
in a sixth step, subsequent to the fourth and fifth steps, the transfer of the transfer credit amount from the first credit memory of the first telecommunications terminal to the second credit memory assigned to the second telecommunications terminal is authorized by the third-party entity depending on a comparison between the first and second transfer information or depending on a comparison between two items of information derived from the first and second transfer information.

2. The method according to claim 1, wherein the transfer of the transfer credit amount from the first credit memory of the first telecommunications terminal to the second credit memory assigned to the second telecommunications terminal is declined by the third-party entity, depending on the comparison between the first and second transfer information or depending on the comparison between two items of information derived from the first and second transfer information, if the first and second transfer information or the two items of information derived from the first and second transfer information have a difference from one another that exceeds a predetermined measure.

3. The method according to claim 1, wherein in the third method step the first and second telecommunications terminals are brought spatially close to one another and/or subjected to an external effect in such a way that the first sensor signal and the second sensor signal are highly correlated with one another; and
wherein the at least one first sensor and the at least one second sensor are each formed as:
an inertial sensor; and/or
an acoustic sensor; and/or
an optical sensor; and/or
an antenna.

4. The method according to claim 1, characterized in that sensor-related information, in particular sensor calibration information, is exchanged between the first telecommunications terminal (151) and the second telecommunications terminal (152) temporally before, during or after the third method step.

5. The method according to claim 1, wherein the first credit memory is permanently assigned to the first telecommunications terminal and is rigidly connected to the first telecommunications terminal, or the first credit memory (21) is part of the first telecommunications terminal; and
wherein the second credit memory is also permanently assigned to the second telecommunications terminal and is rigidly connected to the second telecommunications terminal, or the second credit memory is part of the second telecommunications terminal.

6. The method according to claim 1, wherein the first event information when generated by the first telecommunications terminal and the second event information when generated by the second telecommunications terminal are in the for of a secret that is provided or transferred to unauthorized third parties in encrypted form to authenticate the transfer of the transfer credit amount.

7. The method according to claim 1, wherein the first credit memory comprises a credit contained in the first credit memory in a secured form.

8. A system for transferring a transfer credit amount from a first credit memory assigned to a first telecommunications terminal to a second credit memory assigned to a second telecommunications terminal, wherein the system comprises:
the first telecommunications terminal;
the second telecommunications terminal; and
a third-party entity;
wherein the first telecommunications terminal comprises at least one first sensor and wherein the second telecommunications terminal comprises at least one second sensor;
wherein the first telecommunications terminal is configured for a credit amount to be added to the first credit memory;
wherein the first telecommunications terminal is configured for the transfer credit amount, as part of the first credit memory, to he selected for transfer;
wherein the first and second telecommunications terminals are configured to be brought spatially close to one another and wherein the first telecommunications terminal is configured to generate first event information on the basis of a first sensor signal from the at least one first sensor of the first telecommunications terminal, and wherein the second telecommunications terminal is configured to generate second event information on the basis of a second sensor signal from the at least one second sensor of the second telecommunications terminal;
wherein the first telecommunications terminal is configured to transfer first transfer information to the third-party entity, wherein the first transfer information is the first event information or encrypted and/or anonymized event information generated in accordance with the first event information;
wherein the second telecommunications terminal is configured to transfer second transfer information to the third-party entity, wherein the second transfer information is the second event information or encrypted and/or anonymized event information generated in accordance with the second event information; and
wherein the third-party entity is configured to authorize the transfer of the transfer credit amount from the first credit memory of the first telecommunications terminal to the second credit memory assigned to the second telecommunications terminal depending on a comparison between the first and second transfer information or depending on a comparison between two items of information derived from the first and second transfer information, and to decline the transfer of the transfer credit amount from the first credit memory of the first telecommunications terminal to the second credit memory assigned to the second telecommunications terminal if the first and second transfer information or the two items of information derived from the first and second transfer information have a difference from one another that exceeds a predetermined measure.

9. The system according to claim 8, wherein the third-party entity is a clearing house.

10-13. (canceled)

14. A non-transitory computer-readable medium having processor-executable instructions stored thereon for transferring a transfer credit amount from a first credit memory assigned to a first telecommunications terminal to a second credit memory assigned to a second telecommunications terminal, wherein the first telecommunications terminal comprises at least one first sensor and wherein the second telecommunications terminal comprises at least one second sensor, wherein the processor-executable instructions, when executed, facilitate performance of the following steps:
in a first step a credit amount is added to the first credit memory;
in a second step, subsequent to the first step, the transfer credit amount, as part of the first credit memory, is selected for transfer;
in a third step, subsequent to the second step, the first and second telecommunications terminals are brought spatially close to one another and first event information is generated by the first telecommunications terminal on the basis of a first sensor signal from the at least one first sensor of the first telecommunications terminal, and second event information is generated by the second telecommunications terminal on the basis of a second sensor signal from the at least one second sensor of the second telecommunications terminal;
in a fourth step, subsequent to the third step, first transfer information is transferred by the first telecommunications terminal to a third-party entity, wherein the first transfer information is the first event information or encrypted and/or anonyrnized event information generated in accordance with the first event information;
in a fifth step, subsequent to the third step, second transfer information is transferred by the second telecommunications terminal to the third-party entity, wherein the second transfer information is the second event information or encrypted and/or anonymized event information generated in accordance with the second event information; and
in a sixth step, subsequent to the fourth and fifth steps, the transfer of the transfer credit amount from the first credit memory of the first telecommunications terminal to the second credit memory assigned to the second telecommunications terminal is authorized by the third-party entity depending on a comparison between the first and second transfer information or depending on a comparison between two items of information derived from the first and second transfer information.
